(19) United States
(12) Patent Application Publication
(10) Pub. No.: US 2016/0298991 A1
(43) Pub. Date: Oct. 13, 2016

(54) FLOWMETER AND METHOD OF FORMING THE SAME

(71) Applicant: FUNAI ELECTRIC CO., LTD., Osaka (JP)

(72) Inventor: Steve BERGSTEDT, Lexington, KY (US)

(21) Appl. No.: 14/685,046

(22) Filed: Apr. 13, 2015

(51) Int. Cl. G01F 1/69

(52) U.S. Cl. CPC G01F 1/69

(57) ABSTRACT

A flowmeter including a fluid flow channel formed on a substrate that directs a fluid from an upstream position to a downstream position. A heater is disposed between the upstream and downstream positions. A first temperature sensor detects temperature of the fluid at the upstream position and a second temperature sensor detects temperature of the fluid at the downstream position. At least one third temperature sensor detects temperature of the heater. A controller maintains the heater at a predetermined temperature based on the temperature sensed by the at least one third temperature sensor. A flow measurement output circuit generates a gain stage output of a temperature differential between the temperature detected by the first temperature sensor and the temperature detected by the second temperature sensor.

### FIELD

This invention is related to sensors and particularly to flow sensors on MEMS die.

### BACKGROUND

Measuring and dispensing precise amounts of fluid is required in a variety of industrial and medical applications. As the relative amount of fluid becomes smaller the detection issues become significant. Most methods rely on thermal flow gradient sensing with sensing elements that are difficult to locate in thermal proximity to the fluid flow. Processing the sensor detection signal is often accomplished with external circuits that have drawbacks in signal quality due to their remote location and also add increased cost to the design.

### SUMMARY OF THE INVENTION

An object of the present invention is to provide a flowmeter that uses switched capacitor sampling techniques.

Another object of the present invention is to provide a flowmeter that generates an output voltage that is peak detected and converted to a pulse width modulated output using a time sampling ramp waveform.

A flowmeter according to an exemplary embodiment of the present invention comprises: a substrate; a fluid flow channel formed on the substrate that directs a fluid from an upstream position to a downstream position; a heater disposed between the upstream and downstream positions; a first temperature sensor that detects temperature of the fluid at the upstream position; a second temperature sensor that detects temperature of the fluid at the downstream position; at least one third temperature sensor that detects temperature of the heater; a controller that maintains the heater at a predetermined temperature based on the temperature sensed by the at least one third temperature sensor; and a flow measurement output circuit that generates a gain stage output of a temperature differential between the temperature detected by the first temperature sensor and the temperature detected by the second temperature sensor.

A method of fabricating a flowmeter according to an exemplary embodiment of the present invention comprises: providing a substrate; forming a fluid flow channel on the substrate that directs a fluid from an upstream position to a downstream position; disposing a heater between the upstream and downstream positions; disposing a first temperature sensor on the substrate that detects temperature of the fluid at the upstream position; disposing a second temperature sensor on the substrate that detects temperature of the fluid at the downstream position; disposing at least one third temperature sensor on the substrate that detects temperature of the heater; disposing a controller on the substrate that maintains the heater at a predetermined temperature based on the temperature sensed by the at least one third temperature sensor; and disposing a flow measurement output circuit on the substrate that generates a gain stage output of a temperature differential between the temperature detected by the first temperature sensor and the temperature detected by the second temperature sensor.

In at least one exemplary embodiment, the flow measurement output circuit comprises a differential gain stage circuit.

In at least one exemplary embodiment, the differential gain stage circuit comprises a switched capacitor sample and hold circuit.

In at least one exemplary embodiment, the flow measurement output circuit further comprises two phases non-overlapping clocks that control operation of the switched capacitor sample and hold circuit.

In at least one exemplary embodiment, the flow measurement output circuit comprises a peak detect circuit that detects the peak output of the differential gain stage circuit.

In at least one exemplary embodiment, the substrate comprises an undercut section below the heater.

In at least one exemplary embodiment, the first, second and at least one third temperature sensors are SPNP sensors.

In at least one exemplary embodiment, the flowmeter is a microelectromechanical device.

In at least one exemplary embodiment, the step of forming an undercut section comprises deep reactive-ion etching of the substrate.

In at least one exemplary embodiment, the flowmeter is formed using microelectromechanical fabrication processes.

Other features and advantages of embodiments of the invention will become readily apparent from the following detailed description, the accompanying drawings and the appended claims.

### BRIEF DESCRIPTION OF THE DRAWINGS

The features and advantages of exemplary embodiments of the present invention will be more fully understood with reference to the following, detailed description when taken in conjunction with the accompanying figures, wherein:

FIG. 1 is a side cross-sectional view of a flowmeter according to an exemplary embodiment of the present invention;

FIG. 2 is a top cross-sectional view of a flowmeter according to an exemplary embodiment of the present invention;

FIG. 3 is a circuit diagram showing a portion of a differential gain stage circuit useable with a flowmeter according to an exemplary embodiment of the present invention;

FIG. 4 is a digital time diagram showing two phases non-overlapping clocks of the circuit of FIG. 3;

FIG. 5 is a diagram of a flow measurement circuit according to an exemplary embodiment of the present invention; and

FIG. 6 is a flowchart showing a method for fabricating a flowmeter according to an exemplary embodiment of the present invention.

### DETAILED DESCRIPTION

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

A thermal mass flow measurement sensor metering precise quantities of fluid has applications in drug delivery, transporting reagent volumes for on chip laboratories, and microfluidic pumping control systems. In various exemplary embodiments, the invention senses the temperature gradient using switch capacitor sampling techniques to calculate the differential gradient of two substrate bipolar (SPNP) sensors located at opposite ends of the flow direction. The fabrication and nature of SPNP sensors allow them to have better matching characteristics than sensing resistors. Switch capacitor techniques allow for precise gain and minimized offset errors. The sensor sensitivity is enhanced by MEMS processing to remove the thermal mass beneath the heater and the sensors. The two sensors use the same analog network that is switched to eliminate offsets due to device mismatch. The result is a sampled and held output voltage that is peak detected and converted to a pulse width modulated output using a time sampling ramp waveform. The heating circuit that establishes the gradient is controlled by SPNP sensors that are located perpendicular to the direction of the flow.

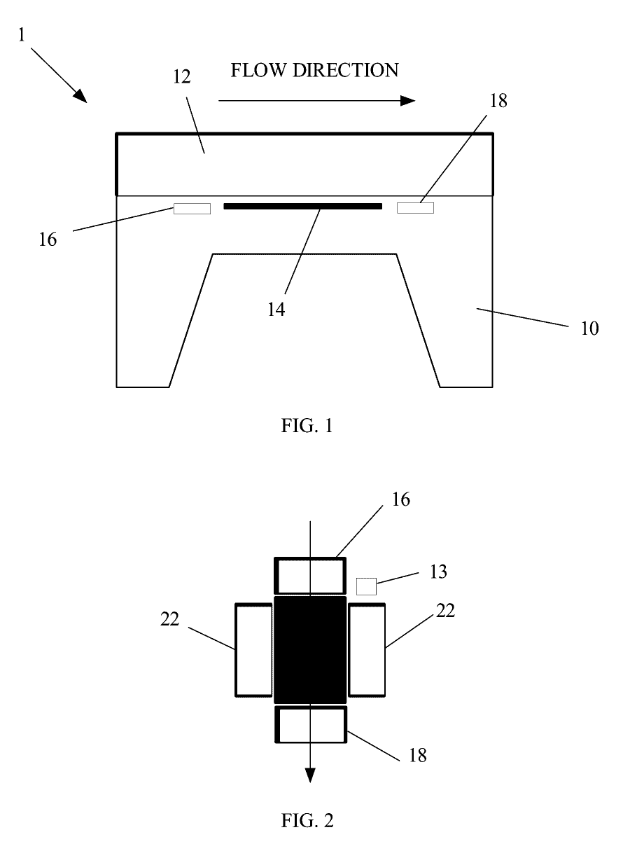

FIG. 1 is a cross-sectional view of a flowmeter, generally designated by reference 1, according to an exemplary embodiment of the present invention. As described in detail herein, the flowmeter 1 is preferably a micro electromechanical system (MEMS) device that includes integrated components including thermal sensors and appropriate circuitry to generate a pulse width modulated output representing a temperature differential of a fluid flowing across the flowmeter 1.

The flowmeter includes a silicon substrate 10 on which is formed a fluid channel 12. A heater 14 is disposed below the fluid channel 12. In an exemplary embodiment, the heater 14 is a resistive heater and is preferably maintained at a predetermined reference temperature by operation of a controller 13 (FIG. 2). The reference temperature may be selected based on, for example, the projected temperature of the environment in which the fluid will operate.

A first temperature sensor 16 is disposed adjacent to the upstream side edge (i.e., a first side edge extending perpendicular to the flow direction) of the heater 14 and a second temperature 18 sensor is disposed at the downstream side edge (i.e., a second side edge extending perpendicular to the flow direction) of the heater 14. As shown in FIG. 2, which is a top cross-sectional view of the flowmeter 1, additional temperature sensors 20, 22 are disposed adjacent to the cross-stream side edges (i.e., edges extending parallel to the direction of flow) of the heater 14. Although two additional temperature sensors are shown, any number of additional sensors may be included in accordance with exemplary embodiments of the present invention. The additional temperature sensors 20, 22 provide temperature measurements of the heater 14 as feedback to the controller 13 so that the heater 14 may be maintained at a predetermined temperature.

Bipolar transistors (BJTs) are frequently used as thermal sensing devices, since a BJT's base-emitter voltage (Vbe) varies with temperature in accordance with:

V_{be}=n_{F}kT/q*ln(I_{c}/I_{S})
where n_{F} is the BJT's emission coefficient, k is Boltzmann's constant, T is absolute temperature, q is the electron charge, I_{C} is the collector current, and I_{S} is the saturation current. Methods of employing BJTs to sense temperature are described, for example, in U.S. Pat. Nos. 5,195,827, 5,982,221, and 6,097,239.

The thermal sensors used in various exemplary embodiments of the present invention are preferably SPNP sensors.

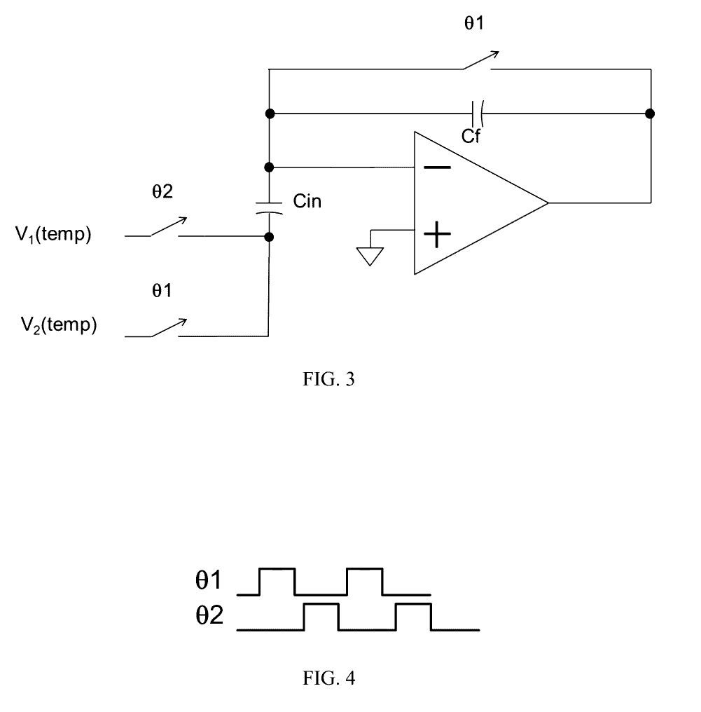

The voltage varying with temperature generated by the first temperature sensor 16 may be referred to as V₁(T) and the voltage varying with temperature generated by the second temperature sensor 18 may be referred to V₂(T). In order to capture the difference between V₁(T) and V₂(T), which corresponds to the temperature gradient between the flow upstream from the heater 14 and the flow downstream from the heater 14, the substrate 10 also carries a differential gain stage circuit. FIG. 3 shows a portion of a differential gain stage circuit, which in this exemplary embodiment includes a switched capacitor sample and hold circuit, generally designated by reference number 24.

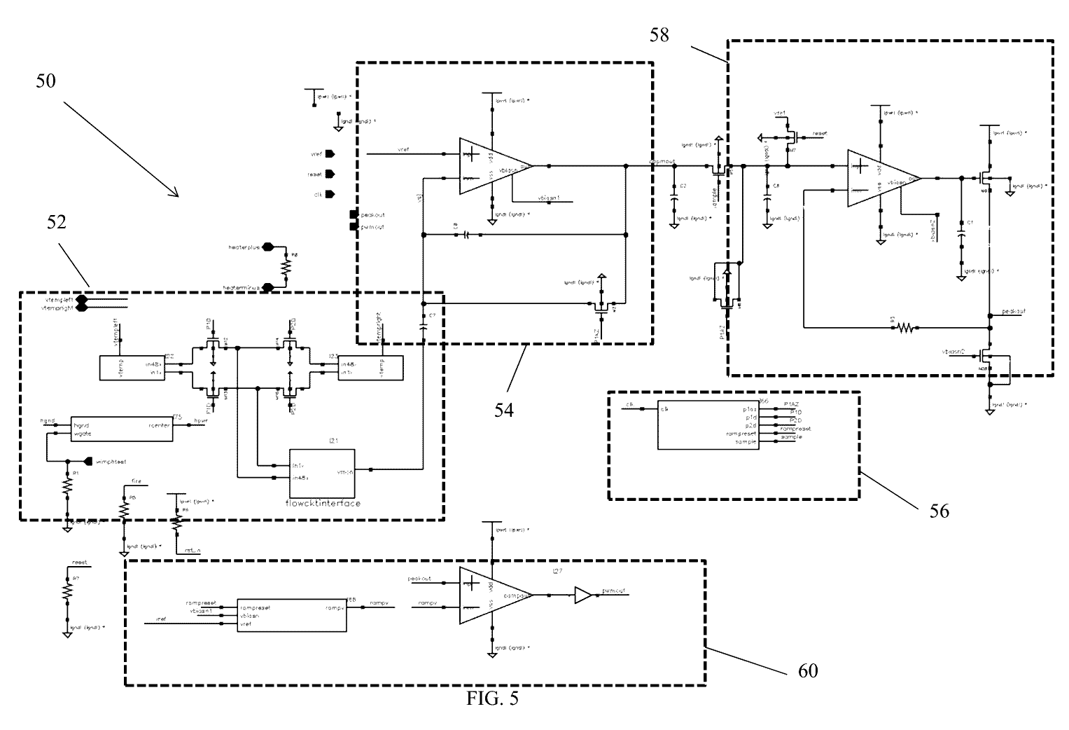

The sample and hold circuit 24 includes switches θ1 and θ2 that operate using two two phases non-overlapping clocks (FIG. 4) so that charge loss is near zero. The capacitors C_{f} and Cᵢₙ may be made of, for example, TaSiN. The charge at θ1 may be determined as follows:

Q_{θ1}=Cᵢₙ=*V₁(T)

The charge at θ2 may be determined as follows:

Q_{θ2}=C_{f}*[V₁(T)−V₂(T)]

So that, due to charge conservation, the temperature differential (expressed as a voltage differential) may be determined as follows:

V_{diff}(T)=Cᵢₙ/C_{f}*[V₁(T)−V₂(T)]

The gain stage output of the differential gain stage circuit may then be converted to pulsewidth so as to generate a digital output, preferably in the form of a time differential (Δt). Pulse width modulation (pwm) is performed by first peak detecting the gain stage output. A voltage ramp is then generated and compared to the peak detect output. The comparison output is the time the voltage ramp is less than the peak detect output.

The pwm output increases with increasing temperature. This information allows a customer to be provided with look-up tables that provide flow characteristics of a fluid, and in particular, for a given fluid, the pulse width (given as Δt) for the fluid can be provided for a range of temperatures or a specified working temperature.

FIG. 5 is a diagram of a flow measurement circuit, generally designated by reference number 50, according to an exemplary embodiment of the present invention. The flow measurement circuit 50 includes a sensing and differential sampling portion 52, a gain stage section 54, the two phase non-overlapping clock generator 56 as previously described, a peak detect section 58 and a ramp generator and PWM output section 60. The clock generator 56 generates the signals that control the switch phases for the gain, peak detection and sampling sections. The switch phases are non-overlapping to control the charge switched onto each of the circuit's capacitors. After a switch has been opened there is a delay before the next switch is closed to prevent charge from moving in the wrong direction. There are actually three clocks generated P1D, P2D, and P1AZ. The signals P1D and P1AZ are essentially the same phase but the P1AZ signal opens slightly before the P1D signal to control charge flow in the auto zero phase. After the P1D signal opens there is a non-overlap time before the P2D closes. Then, after P2D opens there is a non-overlap time before the P1D signal (and the P1AZ) closes again. The cycles repeat as long as power is applied. The clock generator 56 also generates signals to control the PWM output section 60.

The sampling portion 52 has switches, two temperature sensors (upstream and downstream), and an interface that couples a temperature voltage onto capacitor C7. The switches are configured by the clock generator 56 to direct the difference in the temperature voltage between the upstream and downstream sensors to appear on capacitor C7 on clock generator phase P2D.

The gain stage section 54 has an opamp, two capacitors and a switch. The switch is controlled by the clock generator 56 so that the temperature voltage difference (tvd) appearing on capacitor C7 is increased by the ratio of capacitors (gain(vout)=tvd * (C7/C0)). The gain stage section 54 auto-zeros on P1AZ which stores the opamp's offset voltage on capacitor C0. This removes the offset from the gain voltage output but makes the gain output valid only on phase P2D. On phase P1AZ the gain output is the opamp's offset voltage.

The peak detection section 58 is required to make the output voltage continuously valid across both P1D and P2D clock generator phases. The peak detection section 58 has an opamp, switches, capacitors, a resistor and a source follower output stage (sfo). The peak detection section 58 output functions to detect the greatest voltage at its input and hold it until a reset signal is applied. If a temperature voltage difference exists then the peak detect output will hold it indefinitely.

The PWM output section 60 takes the held output from the peak detection section 58 and converts it to a pulse width. The PWM output section 60 includes a ramp generator and a comparator. A voltage ramp is started at the beginning of the P1D clock phase and increases until the end of the P2D clock phase. The ramp voltage is set to start at a voltage lower than the minimum peak detect output and end greater than the maximum expected peak detect output. The comparator output starts at a high state and takes the peak detect output and the ramp and detects when the ramp voltage signal crosses the peak detect voltage and then switches to a low state. Thus the pulse width (time spent in a high state) is proportional to the peak detect output voltage. This allows a digital time measurement to be output instead of the peak detect voltage. Time measurement of digital signals is often easier than voltage measurement.

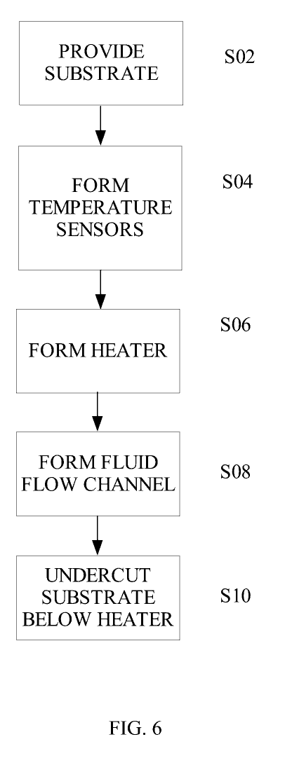

FIG. 6 is a flow chart showing a method of making a flowmeter according to an exemplary embodiment of the present invention. The manufacturing processes according to exemplary embodiments of the present invention use standard MEMS processing techniques, including, for example, deposition, lithography and etching. In step S02 of the method, the substrate 10 is provided. The substrate 10 may be made of, for example, silicon. In step S04 temperature sensors 16, 18, 20 and 22 are formed in the substrate 10, preferably by diffusion. In step S06, the heater 14 is then formed on the substrate. In step S08, a fluid flow channel is formed on the heater, and preferably over the oxide on top of the heater. In step S10, one or more portions of the substrate below the heater 14 are removed by, for example, deep reactive-ion etching (DRIE). In this regard, the heater 14 and the back side DRIE of the substrate increase the overall sensitivity of the flowmeter by decreasing the thermal mass of the substrate and thereby increasing the temperature difference signal.

While particular embodiments of the invention have been illustrated and described, it would be obvious to those skilled in the art that various other changes and modifications may be made without departing from the spirit and scope of the invention. It is therefore intended to cover in the appended claims all such changes and modifications that are within the scope of this invention.

What is claimed is:

1. A flowmeter comprising:
a substrate;
a fluid flow channel formed on the substrate that directs a fluid from an upstream position to a downstream position;
a heater disposed between the upstream and downstream positions;
a first temperature sensor that detects temperature of the fluid at the upstream position;
a second temperature sensor that detects temperature of the fluid at the downstream position;
at least one third temperature sensor that detects temperature of the heater;
a controller that maintains the heater at a predetermined temperature based on the temperature sensed by the at least one third temperature sensor; and
a flow measurement output circuit that generates a gain stage output of a temperature differential between the temperature detected by the first temperature sensor and the temperature detected by the second temperature sensor.

2. The flowmeter of claim 1, wherein the flow measurement output circuit comprises a differential gain stage circuit.

3. The flowmeter of claim 2, wherein the differential gain stage circuit comprises a switched capacitor sample and hold circuit.

4. The flowmeter of claim 3, wherein the flow measurement output circuit further comprises two phases non-overlapping clocks that control operation of the switched capacitor sample and hold circuit.

5. The flowmeter of claim 2, wherein the flow measurement output circuit comprises a peak detect circuit that detects the peak output of the differential gain stage circuit.

6. The flowmeter of claim 1, wherein the substrate comprises an undercut section below the heater.

7. The flowmeter of claim 1, wherein the first, second and at least one third temperature sensors are SPNP sensors.

8. The flowmeter of claim 1, wherein the flowmeter is a microelectromechanical device.

9. A method of fabricating a flowmeter, comprising:
providing a substrate;
forming a fluid flow channel on the substrate that directs a fluid from an upstream position to a downstream position;
disposing a heater between the upstream and downstream positions;
disposing a first temperature sensor on the substrate that detects temperature of the fluid at the upstream position;
disposing a second temperature sensor on the substrate that detects temperature of the fluid at the downstream position;
disposing at least one third temperature sensor on the substrate that detects temperature of the heater;
disposing a controller on the substrate that maintains the heater at a predetermined temperature based on the temperature sensed by the at least one third temperature sensor; and
disposing a flow measurement output circuit on the substrate that generates a gain stage output of a temperature differential between the temperature detected by the first temperature sensor and the temperature detected by the second temperature sensor.

10. The method of claim 9, wherein the flow measurement output circuit comprises a differential gain stage circuit.

11. The method of claim 10, wherein the differential gain stage circuit comprises a switched capacitor sample and hold circuit.

12. The method of claim 11, wherein the flow measurement output circuit further comprises two phases non-overlapping clocks that control operation of the switched capacitor sample and hold circuit.

13. The method of claim 11, wherein the flow measurement output circuit comprises a peak detect circuit that detects the peak output of the differential gain stage circuit.

14. The method of claim 9, further comprising the step of forming an undercut section in the substrate below the heater.

15. The method of claim 14, wherein the step of forming an undercut section comprises deep reactive-ion etching of the substrate.

16. The method of claim 9, wherein the first, second and at least one third temperature sensors are SPNP sensors.

17. The method of claim 1, wherein the steps of the method comprise microelectromechanical fabrication processes.
